(19) United States
(12) Patent Application Publication
(10) Pub. No.: US 2007/0043803 A1
(43) Pub. Date: Feb. 22, 2007

(54) Automatic specification of semantic services in response to declarative queries of sensor networks

(75) Inventors: Kamin Whitehouse, Berkeley, CA (US); Feng Zhao, Issaquah, WA (US); Jie Liu, Sammamish, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/193,018

(22) Filed: Jul. 29, 2005

(51) Int. Cl. G06F 15/16

(52) U.S. Cl. 709/201

(57) ABSTRACT

Automatic specification of semantic services in response to declarative queries of sensor networks is described herein. Declarative Queries from users are received, and a set of sensors and related semantic services are automatically planned that prove or solve the input query against a network of sensors deployed to monitor one or more regions of interest. The plan is further analyzed to determine whether any pre-existing services provide event streams that may be useful in proving the query. If so, these existing event streams are utilized in proving the input query, thereby minimizing the creation of redundant or duplicated semantic services and reusing existing services where possible. This analysis also contributes to compact service graphs that prove queries efficiently. The architecture also enables users to specify constraints or ranges of constraints applicable to queries. These constraints enable different services to utilize event streams originating from sensors, and promote greater resource utilization.

### BACKGROUND

Networks of sensors are widely deployed in a variety of applications. For example, building and office facilities may be equipped with HVAC and card key sensors, road intersections and highways may be monitored by vehicle detection sensors, and residential, commercial, and industrial buildings may be protected by fire or other security-related sensors. Individual sensors may communicate with one another or with a central monitoring point via suitable communication networks.

Despite their potential for sensing and providing information, these sensors can be underutilized because the raw data read and generated by the sensors may not be readily consumable by end users. For example, a building manager may want to be alerted to excess building activity occurring over weekends, or a safety engineer may want a histogram of vehicle speeds in a parking garage. However, to obtain and interpret such sensor data, end users may become involved in learning low-level details of programming, manipulating, and communicating with such sensors. The skills and difficulty involved in interacting with these sensors at a low level may dissuade at least some end users from using sensors and related sensor networks to their fullest.

Particular sensors within the sensor network may be shared among or between different end users. Thus, resource contention can result when multiple end users seek access to particular sensors simultaneously. Moreover, different end users may request conflicting or contradictory data from particular sensors. For example, a first end user might want readings taken by a given sensor at a first frequency, while a second end user might want readings taken by the same sensor at a second frequency. Finally, different end users may request sensor data that already has been or is being sampled in response to requests from other end users, thereby introducing a level of inefficiency into the sensor network, with multiple streams of redundant information flowing within the network.

### SUMMARY

Automatic specification of semantic services in response to declarative queries of sensor networks is described herein. An architecture described herein receives queries from users in declarative form, and automatically plans a set of sensors and related semantic services that prove or solve the input query against a network of sensors deployed to monitor one or more regions of interest. The plan of sensors or semantic services is further analyzed to determine whether any pre-existing services are providing event streams that may be useful in proving the input query. If so, these existing event streams are utilized in proving the input query, thereby minimizing the creation of redundant or duplicated semantic services and reusing existing semantic services where possible. This analysis also contributes to compact service graphs that answer queries efficiently.

The architecture also enables users to specify constraints or a range of constraints applicable to queries. These constraints can enable a variety of semantic services to utilize event streams originating from sensors, and therefore enable greater resource utilization across the sensor network.

This Summary is provided to introduce a selection of concepts in a simplified form that are further described below in the Detailed Description. This Summary is not intended to identify key features to essential features of the claimed subject matter, nor is it intended to be used as an aid in determining the scope of the claimed subject matter.

### BRIEF DESCRIPTION OF THE DRAWINGS

The teachings herein are described with reference to the accompanying figures. In the figures, the left-most digit(s) of a reference number identifies the figure in which the reference number first appears. The use of the same reference numbers in different figures indicates similar or identical items.

FIG. 1 is a combined block and flow diagram illustrating an architecture for supporting declarative queries of sensors networks.

FIG. 2 is a combined block and flow diagram illustrating a sequence of semantic services, event streams produced thereby, and properties of example events.

FIG. 3 is a data flow diagram illustrating a data flow related to the architecture shown in FIG. 1.

FIG. 4 is a block diagram illustrating a sensor infrastructure in which the architecture shown in FIG. 1 may be deployed.

FIG. 5 is a block diagram illustrating a set of services and event streams that prove a first example application of the teachings herein.

FIG. 6 is a block diagram illustrating a set of services and event streams that prove a second example application of the teachings herein.

FIG. 7 is a block diagram illustrating a distributed architecture for implementing a Break Beam Service and an Object Detection Service as shown in FIG. 5.

FIG. 8 is a block diagram illustrating a centralized architecture for implementing the Break Beam Service and the Object Detection Service as described above in connection with FIGS. 5 and 7.

FIG. 9 is a block diagram illustrating a proof constructed using a modified inference technique as taught herein.

FIG. 10 is a block diagram illustrating a proof constructed using a pure backward chaining technique.

FIG. 11 is a picture of a graphical user interface that can be presented to users by the architecture and used to query sensor networks.

FIG. 12 is a block diagram illustrating a composite service graph that represents the services generated for each of three example queries discussed herein.

FIG. 13 is a flowchart illustrating a flow performed to process queries according to the teachings herein.

FIG. 14 illustrates an exemplary computing environment within which automatic specification of semantic services in response to declarative queries of sensor networks, as well as the computing, network, and system architectures described herein, can be either fully or partially implemented.

### DETAILED DESCRIPTION

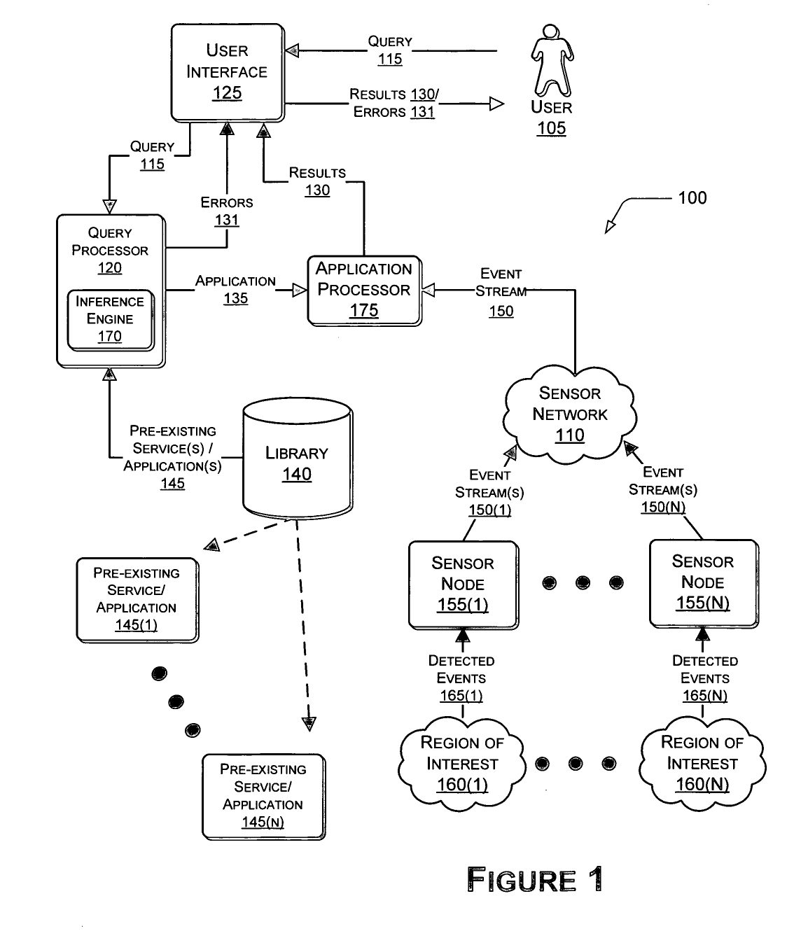

FIG. 1 illustrates an architecture 100 for supporting automatic specification of semantic services in response to declarative queries of sensor networks. The architecture 100 allows a user 105 to query a sensor network 110 using a declarative statement such as, “I want the speeds of vehicles near the entrance of the parking garage.” In a declarative programming approach, as opposed to an imperative approach, the users 105 specify an end goal in terms of what semantic information to collect, and the architecture 100 automatically specifies and connects the necessary components to achieve that goal. The various aspects of the architecture 100 discussed herein enables compositions of components or modules that can perform semantic inference to provide the information requested by the user 105.

The architecture 100 presented herein provides a declarative language for describing and composing event-based sensor services. There are several benefits to this architecture 100:
Declarative programming is easier to understand than low-level, distributed programming and allows non-technical people to query high-level information from sensor networks.
The declarative language allows the users 105 to specify desired quality of service (QoS) trade-offs and have a query processor execute on them, rather than writing imperative code that must provide the QoS.
The architecture 100 allows multiple users 105 to task and re-task the sensor network concurrently, optimizing for reuse of services between applications and automatically resolving resource conflicts.

Together, the declarative programming model and the constraint-based planning engine in our service-oriented architecture let non-technical users to quickly extract semantic information from raw sensor data, thus addressing one of the most significant barriers to widespread adoption today.

The architecture 100 allows multiple, independent users 105 to use the same sensor networks 110 simultaneously. While FIG. 1 shows one user 105, any number of users 105 can use the architecture 100. Architecture 100 also automatically shares the resources of the sensor networks 110 among the users 105, and resolves conflicts between applications associated with various users 105. The architecture 100 also allows the users 105 to place constraints or objective functions over quality of service parameters, such as, “I want the confidence of the speed estimates to be greater than 90%,” or “I want to minimize the total number of radio messages.”

A user 105 poses a query 115 to a query processor 120 via a user interface 125, and receives results 130 or error messages 131 of the query 115 via the user interface 125. Alternatively, the results 130 or error messages 131 may be received via a different user interface 125. Depending on whether the query 115 was successful or not, the response may be either results 130 to the query 115, or error messages 131 stating that the query 115 could not be completed successfully. The error messages 131 can further detail the reasons for the failure. For example, if a particular query 115 cannot be answered, the errors 131 can indicate failure. However, if the query 115 from the user 105 is goal-oriented, the errors 131 may provide actionable error messages. For example, the error message 131 could provide suggestions like: “To answer this query, you can add a magnetometer sensor to region XYZ.” This functionality is made possible by analyzing the failure points in a failed query 115 and presenting any unproven pre-conditions to the user 105.

The user interface 125 forwards the query 115 to the query processor 120, which analyzes the query 115 and employs an inference engine 170 to formulate an application 135 to prove the query 115. The inference engine 170 decides which sensors and related services would provide semantic information responsive to the user's query 115, formulates the application 135 to incorporate the selected sensors 155 and related services, and forwards the application 135 to an application processor. The inference engine 170 can refer to a library or knowledge base (KB) 140 of services from pre-existing applications 145, which may have been built when answering previous queries 115. If the library 140 contains pre-existing applications 145(1) through 145 (N) (collectively, pre-existing applications 145) that answer at least parts of the input query 115, the inference engine 170 can plan the input query 115, at least in part, by building onto such pre-existing applications 145 when formulating the application 135. Otherwise, the inference engine 170 can plan the input query 115 by formulating a new application 135 from completely new services.

Having defined the application 135 that proves the input query 115, the inference engine 170 outputs the application 135 to one or more application processors 175, also referred to herein as microservers. The application processors 175 execute the application 135 against event streams 150 arriving from the sensor network 110, and output the results 130 to the user interface 125. The sensor network 110 includes a plurality of sensor nodes 155(1) through 155(N) (collectively, sensor nodes 155), with each of the sensor nodes 155 including at least one sensor that monitors a respective region of interest 160(1) through 160(N) (collectively, regions of interest 160). In general, as used herein, the letter N as used in connection with a reference numeral can represent any positive integer. Also as used herein, the term “sensor node” includes the one or more sensors, plus any interface hardware or software appropriate to extract data from or to provide instructions to the sensor. Each sensor node 155 detects events of interest 165, and generates an event stream 150 representing a sequence of such events of interest 165.

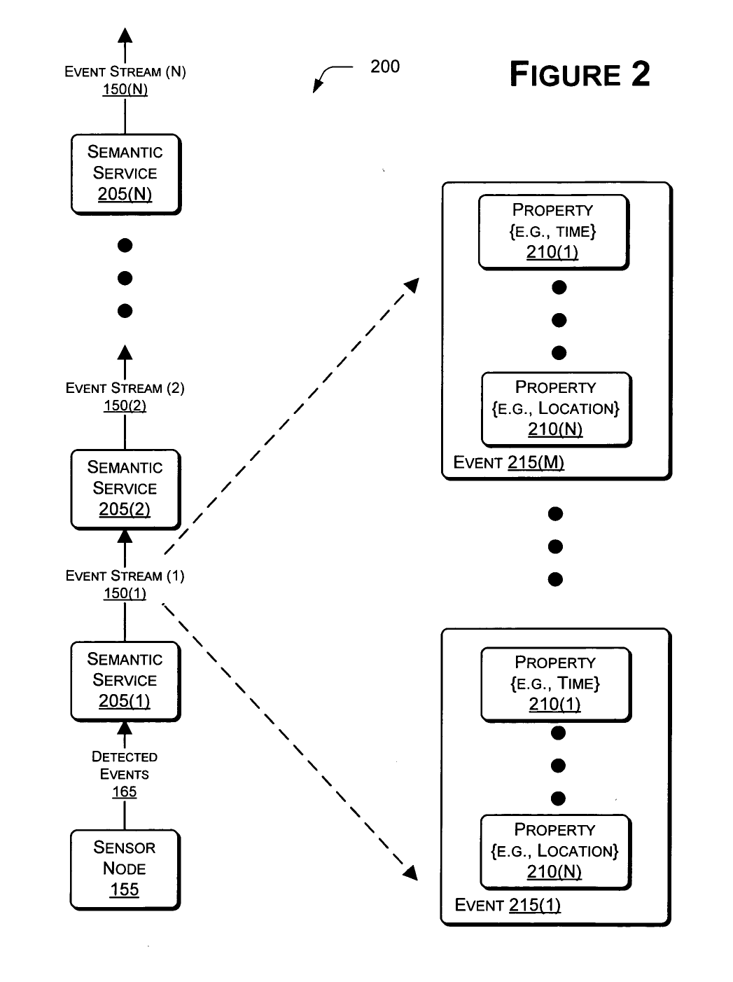

FIG. 2 illustrates semantic services 205(1), 205(2), through 205(N) (collectively, semantic services 205), event streams 150(1), 150(2), through 150(N) (collectively, event streams 150) produced thereby, and properties 210(1) through 210(N) (collectively, properties 210) of example events 215(1) through 215(M) (collectively, events 215). Purely for convenience and clarity of illustration, FIG. 2 shows semantic services 205, event streams 150, and events 215 in a linear relationship. However, this arrangement is understood to be illustrative and non-limiting of the teachings herein. More particularly, the event streams 150, and the events 215 and services 205 related thereto, may merge or split as appropriate in particular implementations.

The architecture 100 shown in FIG. 1 can use a semantic services programming model, where each semantic service 205 is a process that infers semantic information about the world using one or more of the sensor nodes 155, or the outputs from other semantic services, and incorporates this information into an event stream 150. Each semantic service 205 receives an input stream and produces an output stream. Further, each semantic service 205 is associated with a first-order logical description of the semantic information that it receives in its input stream and that it adds to its output stream or that it creates at its output stream. The input and output streams of semantic services 205 can be wired together, producing a sequence of semantic services 205 that operate on a given event stream 150 and modify it as it passes through the semantic services 205.

Each event 215 in an event stream 150 is associated with a data representation that can include one or more properties 210 of interest. For example, the event representations 215 shown in FIG. 2 include respective properties 210 for a time and a location at which the event 215 occurred. It is understood that these properties 210 are shown to illustrate the concepts herein, and are not limiting. Other examples of event properties 210 are discussed elsewhere herein, and further event properties 210 may become apparent to those skilled in the art when considering the teachings herein.

The semantic services programming model enables composition of semantic services 205 that interpret data obtained from the sensor nodes 155, thereby creating new semantic applications. Returning to FIG. 1, the user 105 can pose a query 115 in first-order logic. Afterwards, a set of sensors 155 and semantic services 205 are declared, for example through libraries 140 of pre-existing applications 145 or new applications 135 defined for the input query 115. The query processor 120 can employ an inference engine 170 to decide which sensors 155 and semantic services 205 would provide semantic information responsive to the user's query 115. The semantic services 205 are converted into a set of rules with pre-conditions (i.e., inputs) and post-conditions (i.e., outputs). Sensors 155 are converted into a set of rules with only post-conditions. The inference engine 170 uses a variant of backward-chaining to process the rules. In other words, the inference engine 170 tries to match each element of the query 115 with the post-condition of a rule corresponding to a semantic service 205. If the match is successful, the pre-conditions of that rule are added to the query 115. The process terminates when the query 115 is empty, that is the pre-conditions of all rules in the query 115 are matched with declarations of physical sensors 155.

One difference between pure backward-chaining and service composition as taught herein is that the inference engine 170 instantiates each semantic service 205 during the composition process and reuses previously instantiated services whenever possible. Unlike pure backward chaining, service composition allows mutual dependence between semantic services 205 and provides the ability to check for legal flows of event streams 150, as discussed in further detail below.

The sensor network 110 may include sensors 155 that are built or provided by different hardware vendors. The sensor network 110 may be used repeatedly over long periods of time, for different types of applications, and by independent users 105, perhaps from different organizations entirely. Such use of the sensor network 110 may pose problems, such as sharing resources between independent user queries 115, resolving conflicts between separate groups of users 105, and coordinating between different users 105, groups, and hardware vendors. In the architecture 100, all semantic services 205 can be maintained in a central repository, such as the library 140, along with their complete semantic descriptions. With the semantic services 205 centrally stored, different groups and hardware vendors can share services 205 without needing to share or understand each other's source code. Because the inference engine 170 reuses existing instances of services 205 whenever possible, it automatically and efficiently reuses services, resources, and operations that are being performed by or for other users 105 without the need for explicit, knowing cooperation between the users 105. Finally, a semantic markup language taught herein and used to describe the services 205 is designed to give the query processor 120 as much freedom in query execution as possible. This allows the query processor 120 to automatically resolve resource conflicts, such as when two applications 135 request different sampling rates from the same sensor 155.

In general, different combinations of sensors 155 and services 205 may satisfy a given query 115. In the context of this application, a service 205 may have one or more pre-conditions and one or more post-conditions, while a sensor 155 may have one or more post-conditions. In this sense, a sensor 155 may be considered to be a special case of a service 205. That is, a sensor 155 may be viewed as a service 205 that has no pre-conditions, and a sensor 155 and a service 205 may be considered the same or similar entities.

The markup language taught herein allows the users 105 to specify constraints on quality of service parameters to help select among otherwise equivalent alternatives. For example, the users 105 might specify that the confidence level on car detections should be above 90%, and that latency should be less than 50 milliseconds. In this example, the term latency can refer to the time elapsed between a car passing and the user 105 receiving a corresponding detection report. The query processor or query engine 120 propagates these constraints through the components in a service graph created to prove the user's query 115. If a particular combination of sensors 155 and/or services 205 does not satisfy the user's constraints, the query processor 120 tries another combination. Allowing the users 105 to specify ranges of constraints instead of specific values for constraints enables the architecture 100 to mediate resources between different applications 135. For example, the architecture 100 may provide one application 135 the largest allowable latency in order to meet the confidence requirements of a second application 135, without increasing overall energy consumption in the sensor network 110.

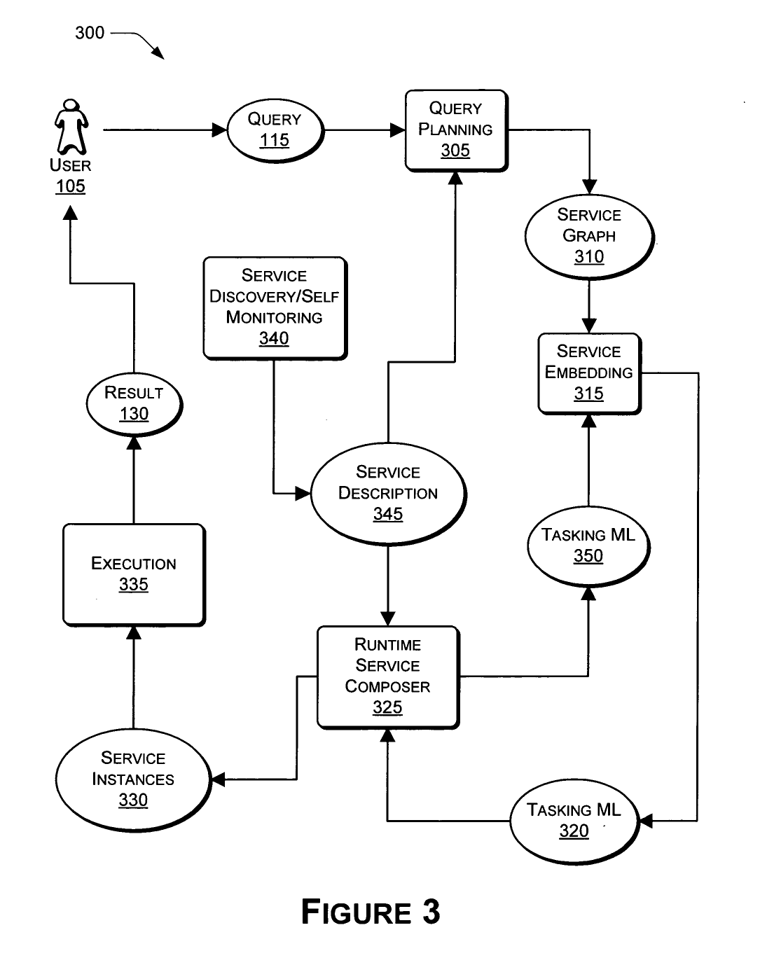

FIG. 3 illustrates a data flow 300 related to the architecture 100 shown in FIG. 1. In the overall architecture 100, when a user 105 poses a query 115 as a predicate on an event stream 150, a query planning process 305 analyzes the input query 115 to define a set of services 205 and event streams 150 that prove the input query 115. The query processor 120 discussed above may perform the query planning process 305. The query planning process 305 generates a service graph 310, which represents the services 205 and event streams 150 that prove the input query 115.

The service graph 310 is then assigned to a set of physical sensor nodes 155 for execution by a service embedding process 315. The service graph 310 resulting from the query planning process 305 can take the form of a skeleton plan or a concrete plan. The skeleton plan can be parameterized by time and other information obtained at run time. This way, the plans can be efficiently re-instantiated without going through the entire planning process, and may provide for more run-time flexibility.

The service embedding process 315 assigns the services 205 represented in the service graph 310 to sensor nodes 155 by using tasking metalanguage (ML) 320. The assignment preserves proximity in data flows and optimizes for resource usage, latency, and load. This processing extends the classic task assignment problem to handle the additional sensor network constraints discussed herein. The scope of the tasking ML 320 differs slightly from the scope of the service graph 310, in that the tasking ML operates on a per-node basis, while the service graph 310 operates on a per task basis.

The service embedding process 315 generates the tasking ML 320 representation of the service graph 310, and forwards the tasking ML 320 to a service runtime composition process 325. The service runtime composition process 325 accepts the tasking ML 320, instantiates services 205 on the assigned node 155 as specified, resolves possible conflicts between tasks and resource availability, creates service instances 330, and forwards the same to an execution process 335. The runtime execution process 335 executes the query 115 in the assigned sensor nodes 155 and application processors or microservers 175. If the query 115 is executed successfully, a result 130 to the query 115 is sent to the user 105. If the runtime process 325 cannot instantiate some portion of a given service graph 310 or the tasking ML 320 corresponding thereto, it can provide the un-instantiated portion of the graph 310 or tasking ML 320 to the service embedding process 315 as feedback 350. This feedback 350 enables the service embedding process 315 to reassign to other sensor nodes 155 those portions of the graph 310 or tasking ML 320 that could not be instantiated on the previously-assigned sensor node 155.

A service discovery process 340 discovers the services 205 that are available within the network 110. These services 205 may be available in, for example, a library such as the library 140, which may contain pre-existing services 205 and/or pre-existing applications 145. The services 205 may also be extracted from pre-existing applications 145.

The service discovery process 340 outputs one or more service descriptions 345 to the service runtime composition process 325 and to the query planning process 305. The service descriptions 345 provided to the query planning process 305 for given services 205 can include an interface specification for each service 205. This interface specification for a given service 205 can specify, for example, pre- or post-conditions for that service 205. The service descriptions 345 provided to the service runtime composition process 325 can include the interface specifications for one or more given services 205, and can also include an implementation of the service executable by the runtime process 325.

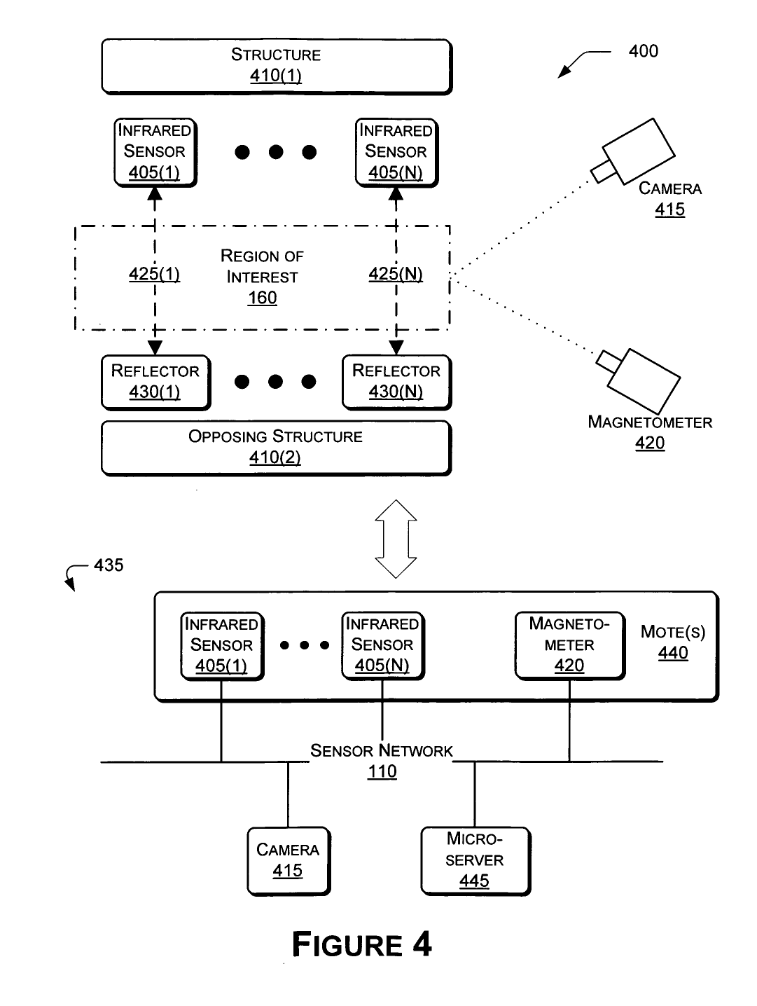

FIG. 4 illustrates a sensor infrastructure 400 in which the architecture 100 shown in FIG. 1 may be deployed. To facilitate discussion, but not to limit the teachings herein, assume that the sensor infrastructure 400 is deployed in a parking garage. This example deployment of the sensor infrastructure 400 is used to demonstrate the semantic descriptions of several services 205 and their use in responding to three queries 115 from three different users 105.

The sensor infrastructure 400 can include three different types of illustrative but non-limiting sensors. First, one or more infrared break-beam sensors 405(1) through 405(N) (collectively, break-beam sensors 405) can be mounted to opposing structures 410(1) and 410(2) (collectively, structure 410). Second, a camera 415 (for example, a web camera) can be positioned to monitor a region of interest 160 between the opposing structures 410. Finally, a magnetometer 420 can be positioned to monitor the region of interest 160.

The break-beam sensors 405 operate by directing infrared beams 425(1) through 425(N) (collectively, beams 425) against corresponding reflectors 430(1) through 430(N) (collectively, reflectors 430), and detecting the reflected beams 425. If the reflected beams 425 are detected by the break-beam sensors 405, this indicates that nothing is in the region of interest 160 between the emitters of the beams 425 and the reflectors 430. However, when an object comes between a given sensor 405 and its corresponding reflector 430, this object interrupts the path traveled by the beam 425 between the given sensor 405 and its corresponding reflector 430, and prevents the sensor 405 from detecting the reflected beam 425. This indicates to the sensor infrastructure 400 that the object is between the given sensor 405 and its reflector 430, thereby “detecting” the object and locating it somewhere proximate the given sensor 405. When the object moves so that it no longer interrupts the path of the beam 425, the sensor 405 redetects the reflected beam 425, indicating that the object is no longer proximate the sensor 405.

By deploying a plurality of the break-beam sensors 405 and corresponding reflectors 430, the sensor infrastructure 400 can cover a given region of interest 160 and detect objects passing through this region of interest 160. As shown in FIG. 4, the camera 415 and the magnetometer 420 are also deployed to monitor the region of interest 160. Thus, the sensor infrastructure 400 shown in FIG. 4 can use the break-beam sensors 405 to detect an object entering or leaving the region of interest 160, can use the camera 415 to photograph or otherwise record visual data relating to the object, and can use the magnetometer 420 to determine the composition of the object.

Assume that the region of interest 160 is an area in front of an elevator on a given floor of the parking deck. Assume further that all vehicles entering this floor of the parking deck would pass through this region of interest 160, as would most pedestrians using the elevator. If one or more infrared breakbeam sensors 405 are placed in a row across the region of interest 160, approximately 1 m apart and about 0.5 m from the ground, the infrared beams 425 would be broken in succession by any passing human or vehicle. The camera 415 can also be focused on the region of interest 160, and the magnetometer 420 can be placed about 10 m downstream from the region of interest 160. This scenario is used below in the discussion of example queries 115 and services 205 defined and instantiated in response to those queries 115.

FIG. 4 also includes a schematic representation 435 of the sensor network 110. The break-beam sensors 405 and the magnetometer 420 can be controlled by micaZO motes 440, and can communicate wirelessly among themselves or with a microserver 445, such as a headless Upont Cappuccino TX-3 Mini PC. The camera 415 and microserver 445 can also be connected to an Ethernet network (not shown) for communication with entities remote or external to the sensor infrastructure 400.

The sensors 405, 415, and 420 deployed in the example sensor infrastructure 400 may be used for many different purposes. For example, they can detect or infer the presence of humans, motorcycles and cars, as well as their speeds, directions, sizes and, in combination with data from neighboring locations, even their paths through the parking garage. This discussion considers three hypothetical users 105 and how each might use the sensor infrastructure 400 described above for three different example queries 115 or applications 135. First, assume that a Police Officer wants a photograph of all vehicles moving faster than 15 miles per hour (mph) through the region of interest 160. Second, assume that an Employee wants to know when to arrive at work in order to get a parking space on the first floor of the parking deck. Finally, assume that a Safety Engineer wants to know the speeds of cars passing through the region of interest 160 near the elevator to determine whether to install a speed bump to promote pedestrian safety.

The Police Officer's query 115 can be solved by inferring the speeds of vehicles passing through the region of interest 160. An application 135 for this query 115 can use the break-beam sensors 405 to detect moving objects and to estimate their speeds, and can use the camera 415 to photograph objects having the specified speed. This application 135 can also use the magnetometer 420 to provide additional confidence that the observed object is a vehicle.

The Employee's query 115 can be solved by observing the distribution of times when cars are observed on the second floor of the parking deck, passing through the region of interest 160. Presumably, most people would not park on the second floor until there were no open spaces left on the first floor. Vehicles can be detected by either the break-beam sensors 405 or the magnetometer 420. The times at which vehicles are detected in the region of interest 160 on the second floor can be plotted in a histogram for the Employee.

The Safety Engineer's query 115 can be solved by combining aspects of the above two applications. The break-beam sensors 405 can be used to infer the speeds of vehicles, as in the Police Officer's application 135, and these speeds can be plotted in a histogram, as in the Employee's application 135. The foregoing inferences prove the information requested by the Safety Engineer.

All three applications 135 are assumed to run continuously and simultaneously using the same hardware. There are several places where conflicts can arise, such as which sensor nodes 155 are on or off, which program image each node is running, what sampling rates the sensor nodes 155 are using, or the like. Further, all three users 105 are assumed to be from different organizations within an enterprise, and are assumed to be unable to coordinate easily. The discussion herein shows how the sensor infrastructure 400 and related architecture 100 avoids the need for coordination between these three users 105. Furthermore, the discussion herein shows how the architecture 100 is able to reuse functionality from the Police Officer's and the Employee's applications 135 to automatically compose an application 135 for the Safety Engineer.

The Semantic Services Programming Model

The Semantic Services programming model contains at least two elements: event streams 150 and semantic services 205, both of which are discussed in connection with FIG. 2 above. Event streams 150 are sequences of asynchronous events 215 in time, each of which has a set of associated properties 210, such as time and location. The events 215 can represent detections of objects, such as people or cars, and can have properties such as speeds, directions, or identities. Semantic services 205 are processes that infer semantic information about the world using sensors 155, and incorporate this information into event streams 150. Event streams 150 originate at a given semantic service 205, and new properties 210 can be added to the event stream 150 as it is processed by other services 205. For example, one service 205 may infer the presence of an object, another service 205 may identify it as a vehicle, and a third service 205 may infer the speed of that vehicle from the sensor data. In this manner, semantic services 205 can be composed in new ways with different sensors 155 to enable new types of semantic inference about the world.

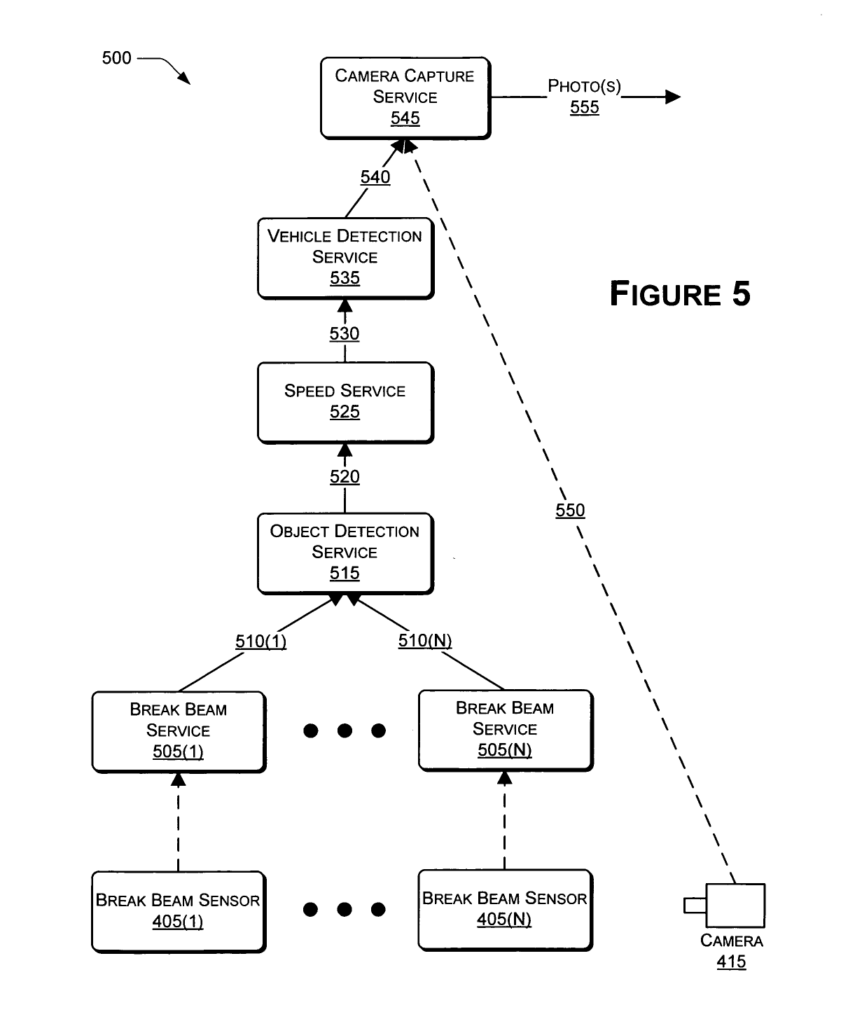

FIG. 5 illustrates a set 500 of services 205 and event streams 150 that prove the example application 135 for the Police Officer introduced above. The following describes how each service 205 shown in FIG. 5 functions:

Break Beam Service 505
Function: A wrapper service around the break-beam sensors 405.
Inputs: None.
Outputs: A stream 510 of break events 215 with at least two properties 210: a rising edge time at which the beam 425 was broken, and a falling edge time at which the beam 425 was redetected.

Object Detection Service 515
Function: Analyzes the streams 510(1) through 510(N) of break events 215 to infer the presence or absence of an object.
Inputs: Multiple break streams 510.
Outputs: An object stream 520, where each object event 215 has at least time and region properties 210, indicating when and where the object was detected.

Speed Service 525
Function: Compares the rising and falling edges of the break events 215 to infer the speed of the object.
Inputs: An object stream 520, and the break streams 510 that support it.
Outputs: An object stream 530, where each event 215 has at least a speed property 210.

Vehicle Detection Service 535
Function: Identifies an event 215 as a car by applying a threshold to the speed of the event.
Inputs: An object stream 530 with at least a speed property 210.
Outputs: An object stream 540, where each event 215 in the stream 540 indicates whether the object is a vehicle.

Camera Capture Service 545
Function: Captures an image 550 from the camera 415 when a vehicle is detected with speed greater than 15 mph.
Inputs: An object stream 540 with at least vehicle and speed properties 210.
Outputs: An object stream 555, where each event 215 has at least a photo property 210.

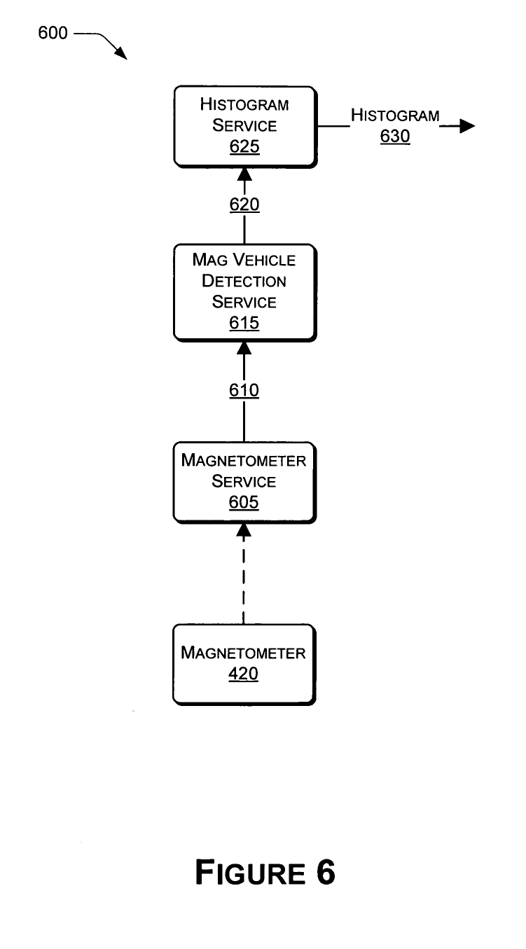

FIG. 6 illustrates a set 600 of services 205 and event streams 150 that prove the example application 135 for the Employee introduced above. The following describes how each service 205 shown in FIG. 6 functions:

Magnetometer Service 605
Function: A wrapper service around the magnetometer 420.
Inputs: None.
Outputs: A stream 610 of magnetometer events 215 with at least a property 210 indicating the magnetic field in the region of interest 160.

Magnetic (“Mag”) Vehicle Detection Service 615
Function: Analyzes the magnetometer stream 610 to infer the presence of vehicles.
Inputs: A magnetometer stream 610.
Outputs: An object stream 620, where each object event 215 has at least time and region properties 210 indicating where and when it was detected, as well as a property 210 indicating that the object is a vehicle.

Histogram Service 625
Function: Plots the time properties 210 of an event stream as a histogram.
Inputs: An object stream 620 with at least a vehicle property 210.
Outputs: A histogram stream 630, where each event 215 contains an update to the histogram.

Although a given event stream 150 may originate at a given service 205, the event stream 150 is not necessarily processed by other services 205 in a linear fashion. For example, a user 105 may want to take pictures of both speeding vehicles and pedestrians. To facilitate the branching and merging of event streams 150, the service 205 that originates the event stream 150 (for example, the Object Detection Service 515) can assign each event 215 in the stream a unique identifier (ID).

The semantic services 205 as described herein can be implemented differently from both web services and from software components, such as NesC modules. NesC™ (pronounced “NES-see”) is an extension to the C programming language designed to embody the structuring concepts and execution model of TinyOS™, which is an event-driven operating system designed for sensor network nodes that have very limited resources (e.g., 8 K bytes of program memory, 512 bytes of RAM). Semantic services 205 can be connected by wiring them together in output-to-input fashion. Further, the semantic services 205 generally communicate through a publish/subscribe mechanism, by placing events into an output buffer, where they are read by subscribing services. This communication scheme differs from the event/command semantics in NeSC™, where a module effectively evokes the function of another module. This communication scheme is also different from Web Services, which do not usually communicate directly but instead generally communicate through a third entity that orchestrates the communications into a single workflow.

One function of the semantic services 205 is to infer new information about the world, and to encode this information into an event stream 150. Communication or computational operations are generally internal to a given service. This scheme is different from a NesC module, whose function is typically to mechanically move data from one node to another; the inference of information about the world is often an emergent behavior from the collaboration of many NesC modules. Semantic services 205 are thus a higher-level programming abstraction than NesC modules. In some implementations of the teachings herein, semantic services 205 can be built from NesC modules.

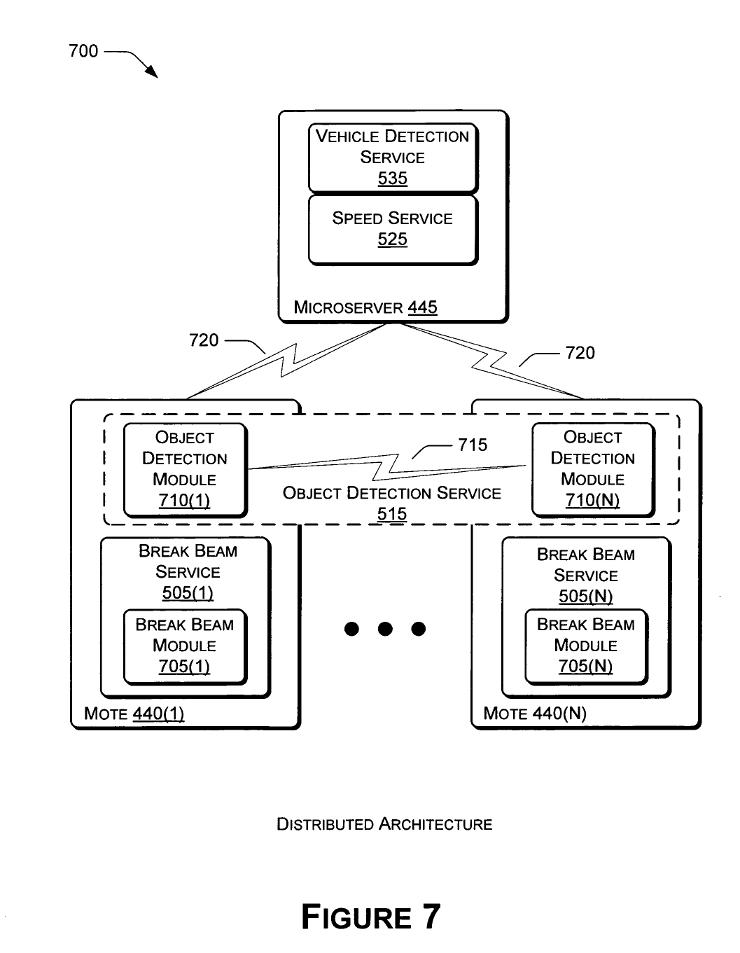

FIG. 7 illustrates a distributed architecture 700 for implementing the Break Beam Service 505 and Object Detection Service 515 shown in FIG. 5. Respective instances of the Break Beam Service 505(1) and 505(N) (collectively, the Break Beam Service 505) and the Break Beam Module 705(1) and 705(N) (collectively, the Break Beam Module 705) can be deployed on the motes 440(1) and 440(N) (collectively, the motes 440). Also deployed on the motes 440 are respective instances of the Object Detection Modules 710(1) through 710(N) (collectively, the Object Detection Modules 710). The Break Beam Modules 705 and the Object Detection Modules 710 can be implemented as respective segments of NesC™ code. As shown in FIG. 7, the Object Detection Service 515 can be distributed between the respective Object Detection Modules 710 that are deployed on corresponding motes 440(1) and 440(N). The Vehicle Detection Service 535 and the Speed Service 525 can be deployed on the microserver 445.

The Break Beam Service 505 and the Object Detection Service 515 can be implemented as, for example, NesC modules. The Break Beam Service 505 can be viewed conceptually as a single NesC module, with respective instances 505(1) through 505(N) of the Break Beam Service 505 running on each of the plurality of break-beam sensors 405 monitoring the region of interest 160. However, the distributed architecture for the Object Detection Service 515 can be viewed conceptually as a combination of a plurality of distributed NesC modules 710(1) through 710(N). These distributed Object Detection Modules 710 can share their break events 215 using radio packets, and elect a leader to analyze them and generate the object detection events 215. Communications 715 between the Object Detection Modules 710 can be internal to the semantic Object Detection Service 515. Communications 720 between the microserver 445 and the respective motes 440 can be external to the Object Detection Service 515. Thus, unlike NesC modules, the semantic services 205 as described herein can be distributed entities.

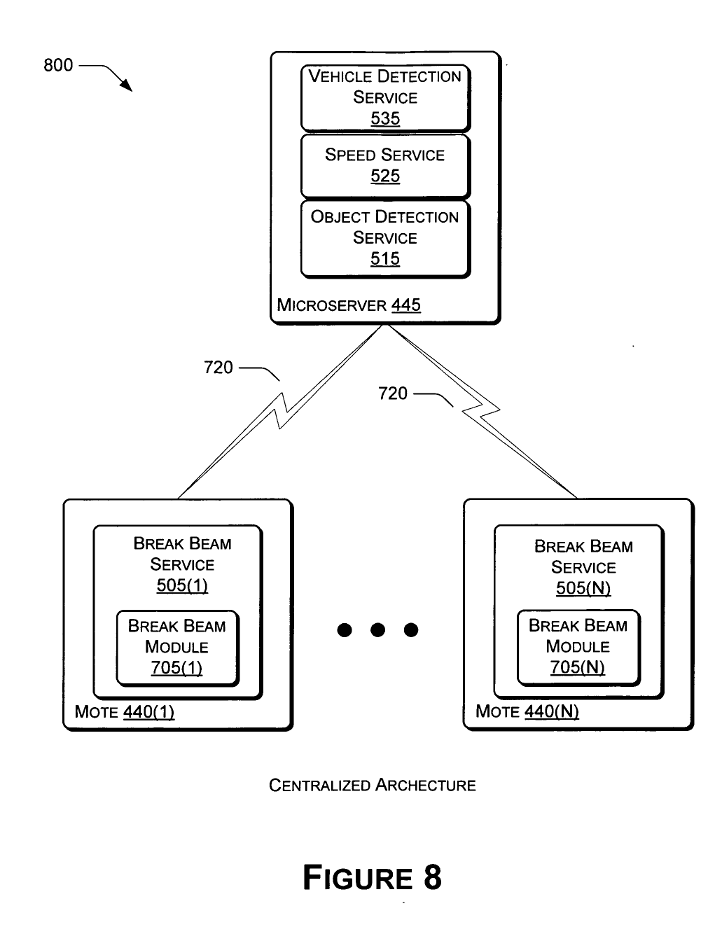

FIG. 8 illustrates a centralized architecture 800 for implementing the Break Beam Service 505 and the Object Detection Service 515 described above in connection with FIGS. 5 and 7. As with FIG. 7, FIG. 8 shows the Break Beam Service 505 and the Break Beam Modules 705(1) through 705(N) as deployed on respective motes 440. However, in FIG. 8, the Object Detection Service 515 is centralized on the microserver 445, along with the Vehicle Detection Service 535 and the Speed Service 525.

The following sections describe how applications 135 can be incorporated into the architecture 100, for example, into a library 140 or other central repository. This incorporation enables the services 205 relating to those applications to be reused by other applications 135, and enables automation of the composition of services 205.

A Service Markup and Query Language

A markup and query language is taught herein that includes a mechanism for declaring the semantics of each service's inputs and outputs, along with the type and location of each sensor 155. These declarations allow the query processor 120 to compose sensor services 205 that are semantically meaningful and consistent with one another.

Background on Logic Programming

The markup and query language can be based on the Prolog language and its constraint logic programming (real) (CLP(R)) extension. Prolog is a logic programming language in which facts and logic rules can be declared and used to prove queries. In Prolog, words beginning with a capital letter (e.g., X) are variables, words beginning with lower case letters (e.g., const) are constants, and words followed by parenthesis are predicates (e.g., value(X,const)). A Prolog rule includes a conjunction of antecedents and their consequent, such as the fact that Z is the grandparent of X, if Z is the parent of Y and Y is the parent of X, expressed by the following rule:

grandparent(Z,X):−parent(Z,Y),parent(Y,X).

A fact is simply a rule with no antecedents, such as the facts that Pat is the parent of Alex and Alex is the parent of Kim, expressed as follows:

parent(pat,alex); and

parent(alex,kim).

A query is a set of antecedents with no consequent. The solution to a query is all sets of bindings to the query variables that make the query true. For example, the following two queries ask who is a grandparent of whom, and who is a grandparent of Pat, respectively. The answer to the first query is that Pat is the grandparent of Kim. The second query evaluates to false, indicating that Pat has no known grandparent.

The First Query:

grandparent(X,Y);
ans: X=pat, Y=kim.

The Second Query:

grandparent(X,pat);
ans: false.

CLP(R) allows the user to declare numeric constraints on variables. Each declared constraint is added to a constraint set and each new constraint declaration evaluates to true if and only if (iff) it is consistent with the existing constraint set. CLP(R) constraints can be combined with Prolog facts, rules and queries by enclosing all CLP(R) statements in brackets. For example, the following rules state that all dates are between 1 and 31, and that the date next week is today's date plus seven, as follows:
is Date(X):−{X=>1,X=<31}; and

nextWeek(X,Y):−{Y=X+7}.

Unlike standard Prolog, CLP(R) queries are answered not by bindings on each variable, but rather by the resulting constraint sets on each variable. For example, a statement declaring that Y is nextWeek of X results in several constraints on both X and Y, as follows:

{is Date(X), is Date(Y), nextWeek(X,Y)};
ans: {X=>I},
   {X=<24},
   {Y=>8},
   {Y=<31}.

In this example, if one date is known, the constraint set on the other variable reduces to a singleton, as follows:

{X=12, is Date(Y), nextWeek(X,Y)};
ans: {Y=19}.

The markup and query language design can build upon CLP(R), and can be implemented using SICStus Prolog™, which has a CLP(R) extension.

Declaring Sensors and Services

The markup and query language as taught herein can define at least eight predicates that can be used to declare sensors 155 and services 205. The predicates appearing in bold type immediately below can be implemented as service processes, the predicates appearing in bold and italic type immediately below can be implemented as top-level predicates, and the predicates appearing in italic type immediately below can be implemented as inner predicates.

sensor(<sensor type>, <region>)

service(<service type>, <needs>, <creates>)

needs(<stream1>, <stream2>, . . . )

creates(<stream1>, <stream2>, . . . )

stream(<identifier>)

isa(<identifier>, <event type>)

property(<identifier>, <property>)

The sensor( ) predicate defines the type and location of each sensor 155. Three examples of sensor declarations follow:

sensor(magnetometer, [[60,0,0],[70,10,10]]);

sensor(camera, [[40,0,0][55,15,15]]); and

sensor(breakBeam, [[10,0,0][12,10, 2]]).

These declarations define three sensors 155 of type magnetometer, camera, and breakBeam, corresponding, for example, to the magnetometer 420, the camera 415, and the break-beam sensor 405. Each sensor 155 is declared to cover a three-dimensional cubic volume defined by a pair of [x, y, z] coordinates. For simplicity, but not limitation, all regions of interest 160 are approximated as three-dimensional cubes, although this approximation is for convenience of description only, and does not limit the teachings herein.

The stream( ), isa( ), and property( ) predicates describe an event stream 150, and the type and properties 210 of its events 215. The service( ), needs( ), and creates( ) predicates describe a service 205, and the semantic information that it needs and creates. In query processing, these are treated as rules, and the pre-conditions and post-conditions of such rules. For example, the Mag Vehicle Detection Service 615 in the Employee's application 135 (further detailed in 600) could be described as a service 205 that uses a magnetometer 420 to detect vehicles, and that creates an event stream 150 with time and location properties 210 representing when and where the vehicles are detected, as follows:

service(magVehicleDetectionService,
needs(
   sensor(magnetometer, R)),
creates(
   stream(X),
   is a(X,vehicle),
   property(X,T,time),
   property(X,R,region))).
      Variable Input Streams

The Histogram Service 625 used for the Employee's application 600 can plot the arrival times of vehicle detection events. This service 625 could be declared only for this purpose, as follows:

service(histogramService,
needs(
   stream(X),
   isa(X,vehicle),
   property(X,T,time),
creates(
   stream(Y),
   isa(Y histogram))).
      However, this description only allows the histogram to plot time properties 210 of vehicle events 215. Even though the actual service 625 as implemented may be able to plot any type of numeric values, this service 625 as declared above cannot be composed to plot any other event streams or properties.

To solve the above problem, the Employee's application 600 could define the Histogram Service 625 to plot any property value of any type of event stream 150, as follows:

service(histogramService,
needs(
   stream(S),
   property(S,V,P),
creates(
   stream(Y),
   isa(Y,histogram),
   property(Y,S, plottedStream))).
   property(Y,P, plottedProperty))).
      The value of S defines the type of stream, and the value of P defines the property 210 that is to be plotted. By defining the input event stream 150 to be a variable, this re-parameterization allows users 105 to query for histograms over different types of event streams 150, and promotes the re-use of the above declaration in connection with a variety of different applications 135 and queries 115 from users 105.
      Querying

A query 115 is a first-order logic description of the event streams 150 and properties 210 requested by the user 105. For example, a simple query 115 could be:

stream(X), is a(X,vehicle).

This query 115 would be true if and only if a set of services 205 could be composed to generate events X that are known to be vehicles. The query processor 120 attempts to generate all such possible service compositions. To constrain the resulting composition set, the user 105 could add more predicates to the query 115. For example, the user 105 could query only for car events in a certain region of interest 160, as follows:

stream(X, object),

isa(X, car),

property(X, [[10,0,0][30,20,20]], region).

A more sophisticated query 115 might request specific relationships between event streams 150. For example, the Employee's query 115 discussed above might request a stream of histogram events 215, where the values to be plotted are the arrival times of vehicle events 215 from a different stream 150. The last line of the query 115 further constrains the plot to only those events detected in a particular region of interest 160, as follows:

stream(Y, histogram),

property(Y, X, stream),

property(Y, time, property),

stream(X),

isa(X, vehicle),

property(X, [[10,0,0][32,12,02]], region).

Queries 115 can be solved using backward chaining. For example, the first three predicates in the Employee's query 115 can be proven by the post-conditions of the Histogram Service 625. In order to use the Histogram Service 625, however, an event stream 150 having time properties 210 should be available. This event stream 150 can be provided by the post-conditions of the Mag Vehicle Detection Service 615, which ultimately uses a magnetometer 420. The last two predicates in the Employee's query 115 above further constrain the stream X to be a vehicle stream originating in a particular region of interest 160. The steps of the final proof become the application 135 that runs on the sensor network 110. The results of executing that application 135 are the query results 130.

Reasoning About Space

Sensors 155 are related to corresponding real-world spatial coordinates, and, as such, the query processor 120 can reason about space. For example, the declaration of the Mag Vehicle Detection Service 615 above uses the same variable R in both the needs( ) predicate and the creates( ) predicate. This variable R indicates that the region of interest 160 in which vehicles are detected is the same region of interest 160 that the magnetometer 420 is sensing.

The Object Detection Service 515 used in the Police Officer's application 135 (further detailed in 500), however, is relatively more involved. It can use a plurality of break-beam sensors 405 in close proximity to each other and with non-intersecting infrared beams 425. A suitable declaration of three sensors 155 for the Police Officer's application 500, which declares the three sensors 155 in specific, known locations, follows:

service(objectDetectionService,
needs(
   sensor(breakbeam,
      [[10,0,0][12,10, 2]]),
   sensor(breakbeam,
      [[20,0,0][22,10, 2]]),
   sensor(breakBeam,
      [[30,0,0][32,10, 2]])),
creates(
   stream(X),
   isa(X,object),
   property(X,T,time),
   property(X,
   [[10,0,0][32,10, 2]])),
   region))).
      The service 205 as declared above, however, cannot be composed with other sets of break beams 425. It also cannot be used in any region of interest 160 besides the one that is hard-coded in the above declaration.

To solve the above problem, the Police Officer's application 500 can use two logic rules about spatial relations, as follows:

subregion(<A>, <B>)

intersection(<A>, <B>, <C>)

The first rule proves that region A is a subregion of region B, while the second rule proves that region A is the intersection of region B and region C. An example of the first rule written in CLP(R) notation follows:

subregion(
[[X1A, Y 1A, Z1A][X2A, Y 2A, Z2A]],
[[X1B, Y 1B, Z1B][X2B, Y 2B, Z2B]]):—
   {min(X1A,X2A)>=min(X1B,X2B),
   min(Y 1A,Y 2A)>=min(Y 1 B,Y 2B),
   min(Z1A,Z2A)>=min(Z 1 B,Z2B),
   max(X1A,X2A)=<max(X1 B,X2B),
   max(Y 1A,Y 2A)=<max(Y 1B,Y 2B),
   max(Y 1A,Z2A)=<max(Z1B,Z2B)}.

The Object Detection Service 515 can now be defined to specify any three break beams 425 that are within a region R, and that do not intersect each other, as follows:

service(objectDetectionService,
needs(
   sensor(breakBeam, R1),
   sensor(breakBeam, R2),
   sensor(breakBeam, R3)),
   subregion(R1,R),
   subregion(R2,R),
   subregion(R3,R),
   \+intersect(,R1,2),
   \+intersect(,R1,R3),
   \+intersect(,R2,R3)),
creates(
   stream(X),
   is a(X,object),
   property(X,T,time),
   property(X,R,region))).
      In Prolog, the line \+ intersect(,R1,2) is true if no region is the intersection of regions R1 and R2. Using this semantic description, the service 205 can be used with any three non-intersecting break beam sensors 405 in any region R.
      Variable Numbers of Input Streams

While reasoning about space is useful to any query processor 120 that utilizes real world sensors 155, arbitrary reasoning ability can also be convenient. Assuming that the query processor 120 uses Prolog, or another language with similar capabilities, arbitrary reasoning capabilities can be added to the query processor 120, as now shown.

For example, the Object Detection Service 515 as described above specifies three break beam sensors 405. Similar services that use two or four sensors 155 would be defined as completely separate services 205. To address this issue, a recursive logic rule could be defined to allow the service 205 to operate over an arbitrary number of break beam sensors 405. The breakGroup predicate, defined below, is true for any group of non-intersecting break beam sensors 405 that are within a specific region of interest 160.

breakGroup(<region>, <initial group>, <group>).

For brevity, the entire definitions of the above regions are not reproduced here. Using this rule, the Object Detection Service 515 could then be redefined to specify a group of at least three break beam sensors 405, as follows:

service(objectDetectionService,
needs(
   breakGroup(R, [ ], Group),
   length(Group,Length),
   Length>=3),
creates(
   stream(X),
   isa(X,obj ect),
   property(X,T,time),
   property(X,R,region))).
      Quality of Service Constraints

Purely logic queries may be answerable by multiple different service graphs 310. For example, the query stream(X), is a(X,vehicle) could be answered by the Employee's Mag Vehicle Detection Service 615 or by the Police Officer's Vehicle Detection Service 535. In general, and especially in a network with many sensors 155i a plurality of similar service graphs 310 may provide the same semantic information. In such cases, the query processor 120 can choose between comparable service graphs 310 based on quality of service (QoS) information, such as total latency, energy consumption, or the confidence of data quality. Accordingly, the teachings herein describe how to declare QoS parameters with each service description, and how to define constraints or objective functions specified in the query 115 that place an ordering on QoS values.

A confidence parameter C can be associated with each event stream 150 by adding a confidence property 210 to events 215 included in that stream 150. Each service 205 can derive the value for that parameter from the sensors 155 and from other services 205 that it may be using. For example, the Object Detection Service 515 may be more confident in its detection rate when it is using more than three break beams 425 for redundancy:

service(objectDetectionService,
needs(
   breakGroup(R, [ ], Group),
   length(Group,Length),
   Length>=3,
   {C=>Length*20, C=<100}),
creates(
   stream(X),
   isa(X,object),
   property(X,T,time),
   property(X,R,region),
   property(X,C,confidence))).
      A query 115 can then request a specific confidence value, and the appropriate number of break beam sensors 405 can be used, while the rest remain off. An example follows:

stream(X), is a(X,object),
property(X, C,confidence), {C>80}.

Similar techniques can be used to constrain latency, power consumption, bandwidth or other QoS parameters. For example, a service 205 that requires 10 ms to compute the speed of an object can define its own latency to be the latency of the previous service plus 10 ms, as follows:

service(speedService,
needs(
   stream(X),
   isa(X,object),
   property(X,LS, latency),
   {L=LS+10}),
creates(
   stream(X, object),
   property(X, S, speed),
   property(X, L, latency))).

The QoS parameters and constraints described herein are generally used only at planning time, i.e., the time at which the query processor 120 composes sensors 155 and services 205 in response to a query 115. It is assumed that all QoS parameters are known at planning time. In the next section, the teachings herein describe how to extract parameter information at planning time, and use this parameter information at runtime.

Runtime Parameters & Conflicts

While Prolog variables defined at planning time are used to wire the instantiations of the services 205, values of CLP(R) variables can also be used at runtime to pass parameters to each service 205. Instead of using the unification of the variables (i.e., relations such as complex inequalities among multiple variables (e.g. end-to-end delays), as opposed to values or simple inequalities of individual variables), each service 205 is passed the resulting constraint sets on each of its parameters. For example, a sensor service 205 that uses a frequency parameter may be able to use any frequency less than 400 Hz. For efficiency reasons, the sensor service 205 may wish to use the lowest frequency possible. This service may be defined as follows:

service(magnetometerService,
needs(
   sensor(magnetometer, R),
   {F<400},
   minimize{F}),
creates(
   stream(X),
   isa(X,mag),
   property(X,T,time),
   property(X,R,region),
   property(X,F,frequency))).
      Minimize is a built in CLP(R) function that sets the variable to the smallest value consistent with all other existing constraints.

Other constraints on the frequency might come from services 205 that use this sensor 155. For example, the Employee's Mag Vehicle Detection Service 615 might specify that the sensor 155 use a frequency that is a multiple of 5 Hz, as follows:

service(magVehicleDetectionService,
needs(
   stream(X),
   isa(X,mag),
   property(X,F,frequency)),
   {F1=5*N, N mod 1=0}),
creates(
   stream(X),
   isa(X,vehicle),
   property(X,T,time),
   property(X,R,region))).
      When these two services 205 are composed, the frequency of the sensor readings is constrained to be a minimum value less than 400 Hz that is also a multiple of 5 Hz. The resulting constraint set is singular, and the query processor 120 determines the sensor frequency to be exactly 5 Hz. This constraint set (while singular) is passed to the instantiation of the service 205 at runtime through the execution engine.

Assuming that service parameters are represented as CLP(R) or similar variables, parameter conflicts may be resolved automatically. For example, if another service 205 were to request that the magnetometer 420 run at a multiple of 12 Hz, the resulting constraint set on the variable F would be:

F is an integer multiple of 5.

F is an integer multiple of 12.

F is less than 400.

F is the minimum value satisfying all of the above.

The constraint set is the singular value of 60, which can be passed to, for example, the Magnetometer Service 605 at runtime.

The resulting constraint sets on QoS parameters can be passed to any service 205 at runtime. For example, the Object Detection Service 515 can be specified by a query 115 to achieve confidence C>80. At planning time, the query processor 120 or query planning process 305 may estimate a confidence level of 100, given five break-beam sensors 405. However, if one sensor 405 fails, or if the nominal confidence values percolating up from the sensors 405 decrease, the Object Detection Service 515 may determine that it can not longer meet the specified confidence constraints. In this case, it will signal an error to the execution engine 325 as feedback 350. This feedback 350 serves to ask the query processor 120 or query planning process 305 for another service graph 310. This process is also known as execution monitoring and re-planning in the artificial intelligence art.

Implementation

Incorporating SICStus Prolog™ with CLP(R) extension, queries 115 are processed by a variant of backward chaining on the declared services 205 and sensors 155. The query planning process 305 includes generating a service graph 310 for proving or answering the query 115. One goal of query processing is to compose a service graph 310 that is as compact as possible. To achieve this goal, it is desirable to share services 205 and pre-existing applications 145 as much as possible among multiple queries 115.

Query Processing

As background, in general backward chaining, each unproven element of the query 115 is matched with the consequent of a rule or fact in the Knowledge Base (KB). If the unproven element is matched with a rule, the antecedents of the rule are proven by matching with another rule or fact. Backward chaining terminates when all antecedents have been matched with facts, and otherwise fails after an exhaustive search of all rules.

The query processor 120 can prove a predicate in the query 115 with the event streams 150 that a service 205 creates. The query processor 120 then proves whatever the service 205 needs. This procedure is repeated recursively until the pre-conditions of all services 205 are satisfied by definitions of physical sensors 155. A difference between general backward chaining and service composition as taught herein is that the inference engine 170 instantiates a virtual representation of each service 205 in the KB every time the service 205 is specified. As will be seen in the examples below, this virtual representation in the KB enables analysis of whether the given service 205 is needed, or whether an equivalent service 145 already exists. It also enables checking the legality of the event streams used to prove a given service 205.

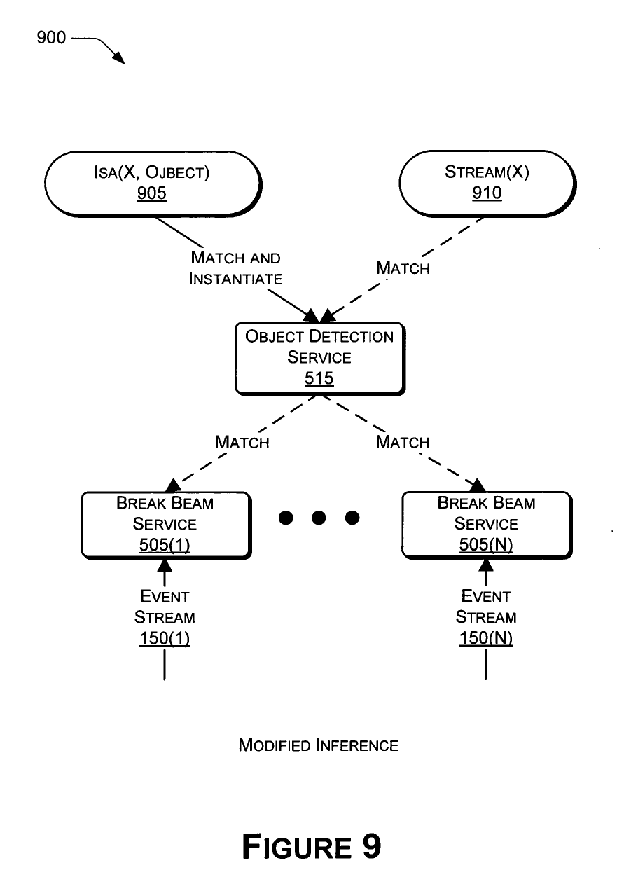

FIG. 9 illustrates a proof 900 constructed using a modified inference technique as taught herein. Consider an example query 115 that asks for an object event stream 150. The example query 115 could contain two predicates 905 and 910, as follows:

isa(X, object), stream(X).

When the inference engine 170 processes the first predicate 905 (is a(X, object), it searches for any service 205 that declares a post-condition in its creates clause that is similar to the pre-condition of the first predicate, and finds the Object Detection Service 515 as shown in FIG. 5. At this point, the inference engine 170 creates a virtual representation of the Object Detection Service 515 in the KB, and adds all the preconditions of the Object Detection Service 515 to the query 115.

The preconditions of the Object Detection Service 515 can be satisfied by, for example, three or more break beam sensors 405. Once these preconditions are satisfied, the inference engine 170 moves on to the second predicate 910 in the query 115: stream(X). Before matching this predicate 910 to service descriptions in the KB, the inference engine 170 compares it to the post-conditions of all virtual services 205 that have already been instantiated. In this case, the predicate 910 matches a post-condition of the existing Object Detection Service 515 instance, and is thus satisfied immediately. The resulting proof is illustrated in FIG. 9. Because the event stream 150 passed to both predicates 905 and 910 come from the same service 205, the proof shown in FIG. 9 is considered legal.

There are several advantages to the above technique. First, it is efficient because results from previous proofs are cached and reused, and many predicates in a query may query the same sub-tree in a proof. Second, it allows mutual dependence, where two services 205 each declare the other as a pre-condition. Mutual dependence cannot generally occur in a pure backward-chaining approach because it would lead to infinite recursion.

A third advantage is that, by causing the inference engine 170 to first check which services 205 already exist, a query 115 can automatically reuse services 205 that were instantiated in response to other queries 115. If two users 105 run queries 115 that can both be answered with an Object Detection Service 515 running over three break beam sensors 405, the Object Detection Service 515 is instantiated only in response to the first query 115; the second query 115 can reuse the previously-instantiated Object Detection Service 515. When the first query 115 terminates, the application processor 175 removes only those services 205 upon which no other services 205 depend, so as to not interrupt execution of the second query 115. In this way, the architecture 100 allows for the automatic sharing of resources and the reuse of processing and bandwidth consumption between independent users 105.

A fourth reason for instantiating virtual representations of services 205 during composition is to ensure proper flow of event streams 150, i.e., that all event streams 150 relied upon for a given proof originate at a given service 205. To perform this analysis, the query processor 120 reasons about the entire existing service graph 310. However, this analysis is generally not possible with a pure backward-chaining approach.

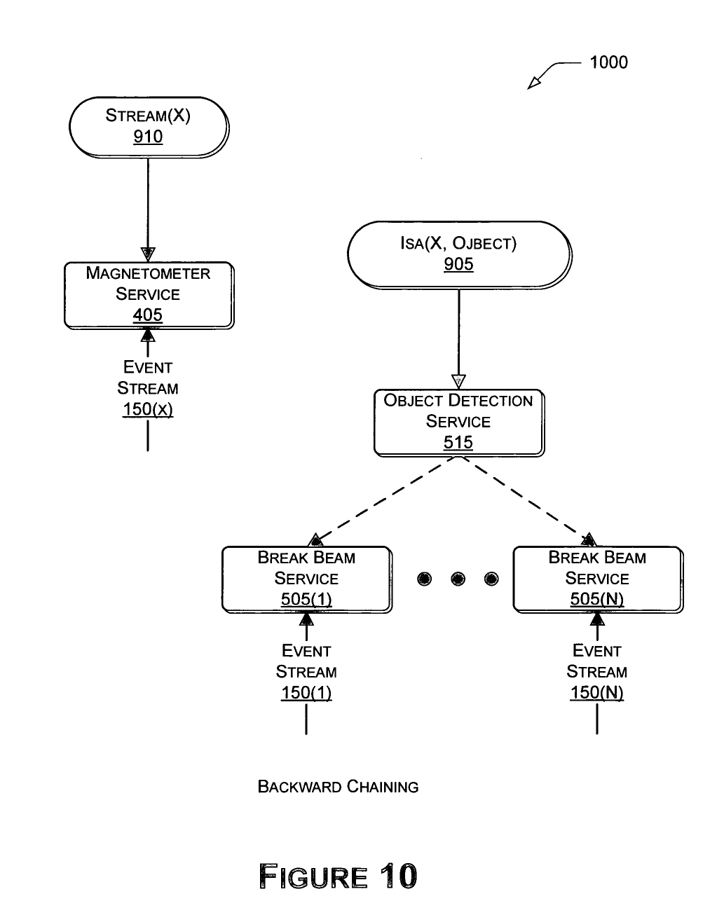

As an example of the foregoing, FIG. 10 illustrates a proof 1000 constructed using a pure backward chaining technique. Consider an example query 115 that asks for an object event stream 150. This example query 115 contains the same predicates 910 and 905 as did the previous example query 115, except that the order of the predicates 910 and 905 is reversed:

stream(X), is a(X, object).

If the inference engine 170 were to use pure backward-chaining, it could prove the first predicate 910 in the query 115 with any service 205 that has an event stream 150 as a post-condition. In this case, the inference engine 170 could try the first service 205 listed in the KB, which may be, for example, the Magnetometer Service 405 shown in FIG. 4. When the inference engine 170 attempts to prove the second predicate 905, this predicate 905 does not match any post-condition of the Magnetometer Service 405, so the inference engine 170 compares the predicate 905 with another service in the KB, for example, the Object Detection Service 515, and completes the proof 1000 of the above example query 115.

The resulting proof 1000, shown in FIG. 10, is not a valid solution to the query 115 because the event streams 150(1), 150(N), and 150(X) proving the two predicates 910 and 905 of the query 115 originate in two different sub-trees of the proof 1000. That is, a first event stream 150(X) passes to the Magnetometer Service 405 and second event streams 150(1) and 150(N) pass to the Object Detection Service 515. Because these two event streams come from different services, these two event streams do not necessarily represent the same stream of detected events 165, and is therefore considered an illegal flow.

By creating a virtual representation of each 205 in the KB, the modified inference technique allows the inference engine 170 to check the entire service graph 310 to verify legal flow after each sub-process of the inference. If the flow is not legal, the inference engine 170 backtracks and tries the next sub-process.

Comparison to Other Automatic Service Composition Approaches

The modified inference technique taught herein differs from other techniques used to automatically compose web services. These other techniques include agent-based, planning-based, and inference-based approaches.

Agent-based approaches perform a heuristic search through the set of all web services, either simulating or actually executing each of them to find a path to a desired resultant state. This technique does not easily transfer to semantic services, because it explicitly assumes a sequential execution model. As noted above, semantic services as taught herein need not be linear or sequential in execution.

Planning-based techniques involve a concurrent execution model can be captured by artificial intelligence techniques, such as Partial Order Planning (POP) and Hierarchical Task Networks (HTN). These techniques assume an initial state of the world so, and can allow a set of simultaneous actions to take place at time tᵢ if the state of the world at that time sᵢ satisfies all of an action's preconditions. The next state of the world, sᵢ₊₁, is the combination of the previous state and the post-conditions of all executed actions. With planning-based techniques, the planner performs a rather mechanical matching of post-conditions, provided at time tᵢ, with pre-conditions needed at time tᵢ₊₁. Typically, these planning-based techniques do not perform any reasoning. However, the architecture 100 performs this type of reasoning to deal with spatial relationships, quality of service properties, and parameter conflicts, among other issues discussed herein.

Purely inference-based approaches reason using an inference engine, which employs a set of facts in a knowledge base (KB) and a set of rules to prove a statement. For example, an address directory service may be described by the rule:

person (X),

name (X, N)=>address(X, A), city(X, C).

An internet mapping service that can provide the directions between two places may be described as:

address(X, XA), city(X, XC),

address(Y, YA), city(Y, YC)=>

directions(X,Y).

These services can be automatically composed to “prove” a query that asks for driving directions between two places, e.g., directions(X,Y), given only the names of two people. The proof itself represents the workflow with which the services can be executed to satisfy the query.

With a purely inference-based approach, proofs are generally tree-based, while most service graphs used by the architecture taught herein are general directed graphs. Because the purely inference-based approach does not use virtual representations of the services when composing the services, this approach generally does not accurately represent the flow of event streams. As discussed above in connection with FIGS. 9 and 10, a proof that involves event streams originating at a given service are considered legal, while a proof that involves event streams originating at different services are considered illegal. Moreover, the purely inference-based approach generally does not represent a service graph with mutual dependence, as discussed herein.

The three example queries 115 introduced above and illustrated in connection with FIGS. 5 and 6 are now revisited to discuss how the architecture 100 can (1) automatically share and reuse resources between independent users 105, and (2) compose services 205 from two different pre-existing applications 145 to create a new semantic composition for a third application 135.

Recall that the Police Officer wishes to photograph each vehicle passing through the region of interest 160 at or above a specified speed. Second, the Employee wishes to determine when he or she should arrive at the garage to get a parking space on the first floor of the garage. Finally, the Safety Officer wishes to determine the speeds of vehicles passing through the region of interest 160 to determine whether placing a speed bump proximate the region of interest 160 is warranted.

If the Police Officer and the Employee are the first users 105 of the architecture 100, or if pre-existing services 205 or applications 145 do not satisfy their queries 115, the architecture 100 may define new services 205 to satisfy their queries 115. To simplify this description, but not to limit the teachings herein, it is assumed that only the services shown in FIGS. 5 and 6 are available to the architecture 100.

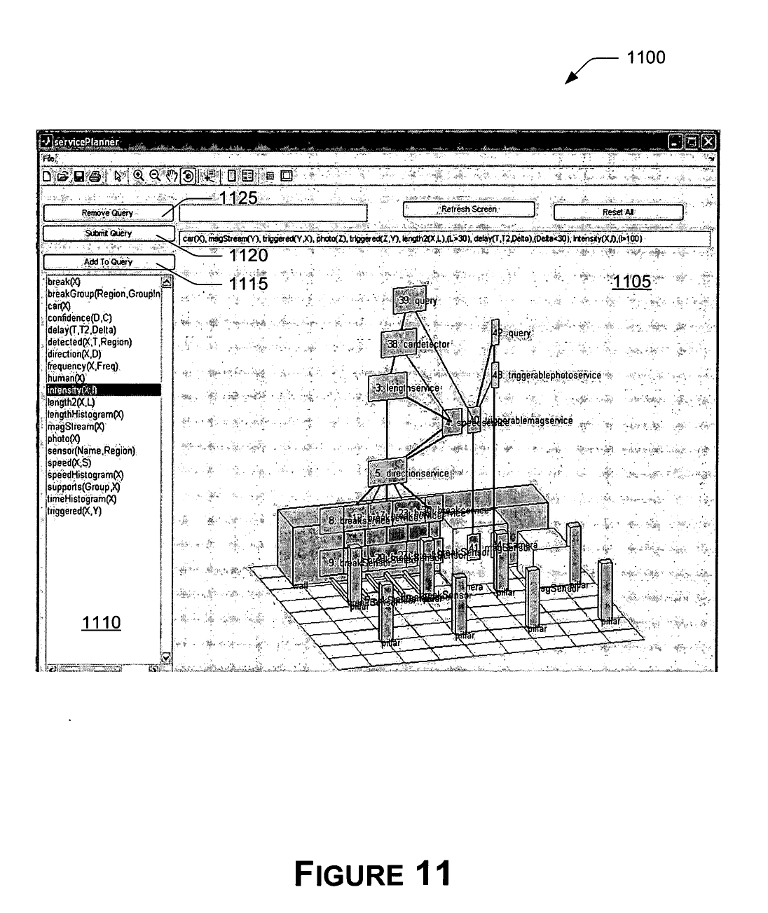

FIG. 11 illustrates a graphical user interface 1100 that can be presented to users 105 by the architecture 100. The graphical user interface 1100 may be presented on the user interface hardware 125 shown in FIG. 1. in an area 1105, The graphical user interface 1100 can provide a three-dimensional rendering of sensors 155 in the sensor network 110, nearby structure 410, and the regions of interest 160 covered by the sensors 155.

The post-conditions of all services 205 instantiated in the KB can be listed in an area 1110. These post-conditions are the only predicates that are used in a query 115, although variable names may be changed to create new compositions and CLP(R) constraints may be added. The users 105 select the appropriate predicates to create their desired queries, using at least in part the buttons 1115, 1120, and 1125. Illustrative queries 115 for each of the above examples involving the Police Officer, the Employee, and the Safety Engineer are presented as follows:

Police Officer stream(X),

property(X,P, photo),
property(X,Y, triggerStream),
property(X,speed, triggerProperty),
stream(Y),
isa(Y,vehicle),
   Employee stream(X),
property(X,H, histogram),
property(X,Y, plottedStream),
property(X,time, plottedProperty),
stream(Y),
isa(Y,vehicle),
   Safety Engineer stream(X),
property(X,H, histogram),
property(X,Y, plottedStream),
property(X,speed, plottedProperty),
stream(Y),
isa(Y vehicle).

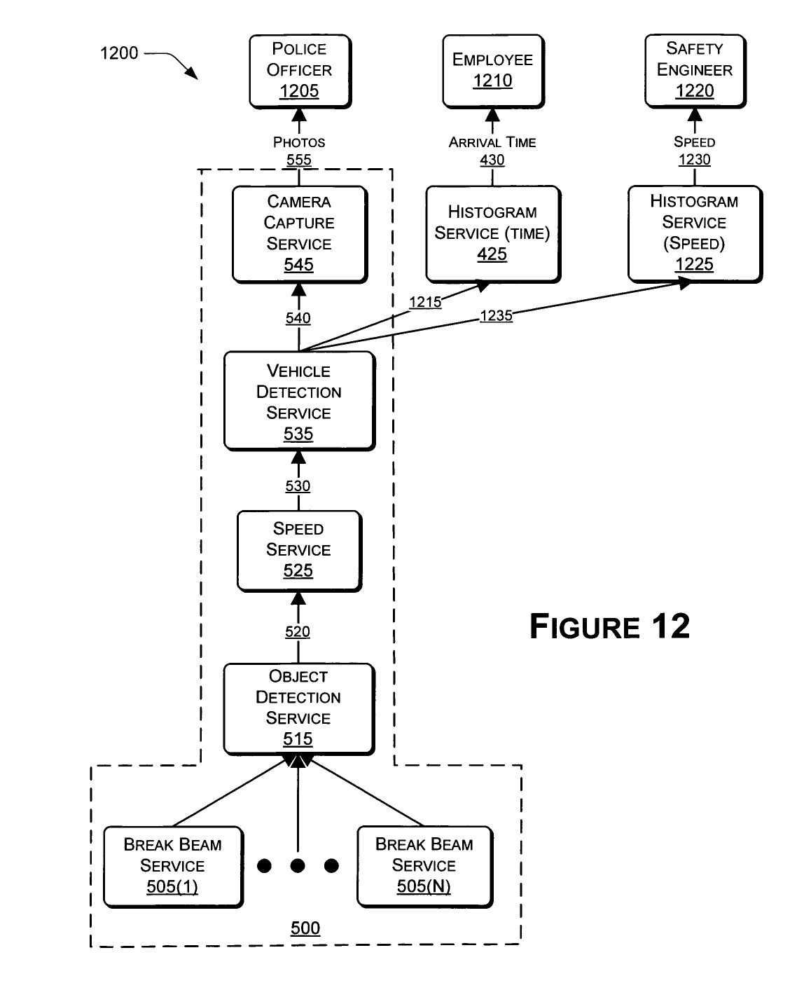

FIG. 12 illustrates a composite service graph 1200 representing the services 205 generated for each of the three example queries 115 discussed above in connection with FIG. 11. When the above query 115 for the Police Officer 1205 is executed, the query processor 120 may generate the service graph 500 shown in FIG. 5, which is reproduced in FIG. 12 for convenience. When the above query 115 for the Employee 1210 is executed, the service graph 600 as shown in FIG. 6 may result, in the absence of any previous queries 115. However, in this example, the query 115 for the Police Officer 1205 has already been executed, resulting in the service graph 500 reproduced in FIG. 12. Thus, applying the teachings herein, the service graph 600 for the Employee, as shown in FIG. 6, may not need to be replicated entirely in FIG. 12. Instead, the query processor 120 checks to see if any part of the service graph 500 for the Police Officer's query 115 may be used to prove the Employee's query.

The query processor 120 compares the services included in the Police Officer's service graph 500, as shown in FIG. 12, are to those services included in the Employee's service graph 600, as shown in FIG. 6. Because the service graph 500 for the Police Officer 1205 did not instantiate a Histogram Service 425, a new Histogram Service 425 is instantiated. Recall that for the Employee's query 115, the Histogram Service 425 reports the times at which vehicles arrive in the region of interest 160 on the second floor of the parking deck. The Employee's service graph 600, as shown in FIG. 6, proves the Employee's query 115 by using an event stream 620 that represents detected vehicles and that is output from the Mag Vehicle Detection Service 615. The Mag Vehicle Detection Service 615, in turn, operates on an event stream 610 originating ultimately from the magnetometer 420, which detects metallic objects passing through the region of interest 160.

Turning now to FIG. 12, note that the service graph 500 generated for the Police Officer's query 115 includes a Vehicle Detection Service 535. Therefore, when proving the Employee's query 115 and having already proven the Police Officer's query 115, the service graph proving the Employee's query 115 need not replicate any service that provides an event stream of detected vehicles, because the service graph 500 already includes the Vehicle Detection Service 535, which produces such an event stream. Accordingly, instead of instantiating a Mag Vehicle Detection service 615 as shown in FIG. 6, which also produces an event stream of detected vehicles, the Vehicle Detection Service 535 instantiated for the Police Officer's application 135 is used. The resulting composite service graph is shown in FIG. 12, with the Histogram Service 425 receiving as input the event stream output from the Vehicle Detection Service 535, as represented by the line 1215. Proving the Employee's application 135 illustrates how the architecture can automatically share resources of the sensor network 110 among independent users 105.

Turning now to proving the query from the Safety Engineer 1220, recall that the Safety Engineer 1220 wants to know the speeds of cars near the elevator to determine whether a speed bump is warranted to promote pedestrian safety. The Safety Engineer's query 115 can be proven by reusing services from both the Police Officer's query 115 and the Employee's query 115. Aspects of the Histogram Service 425 from the Employee's application 135 can be reused, although a new instance 1225 is created because the existing instance of the Histogram Service 425 plots values different than those sought by the Safety Engineer 1220. Namely, the Employee's query 115 seeks arrival times 430 of vehicles, while the Safety Engineer's query 115 seeks the speeds 1230 at which the vehicles are moving when they pass through the region of interest 160. The existing instance of the Vehicle Detection Service 535 from the Employee's application 135, however, can be reused because it infers the speeds of vehicle objects. Accordingly, the input of the new instance 1225 of the Histogram Service 425 is the output from the Vehicle Detection Service 535, as represented by the line 1235. The service graph 1200 shown in FIG. 12 is then sent to the service embedding process and ultimately is executed on the sensor network.

Proving the Safety Engineer's query 115 using aspects of previous queries 115 illustrates further how a new application 135 can be created while minimizing the creation of any new services 205. Existing services 205 from the other two applications were composed to create a semantically new application.

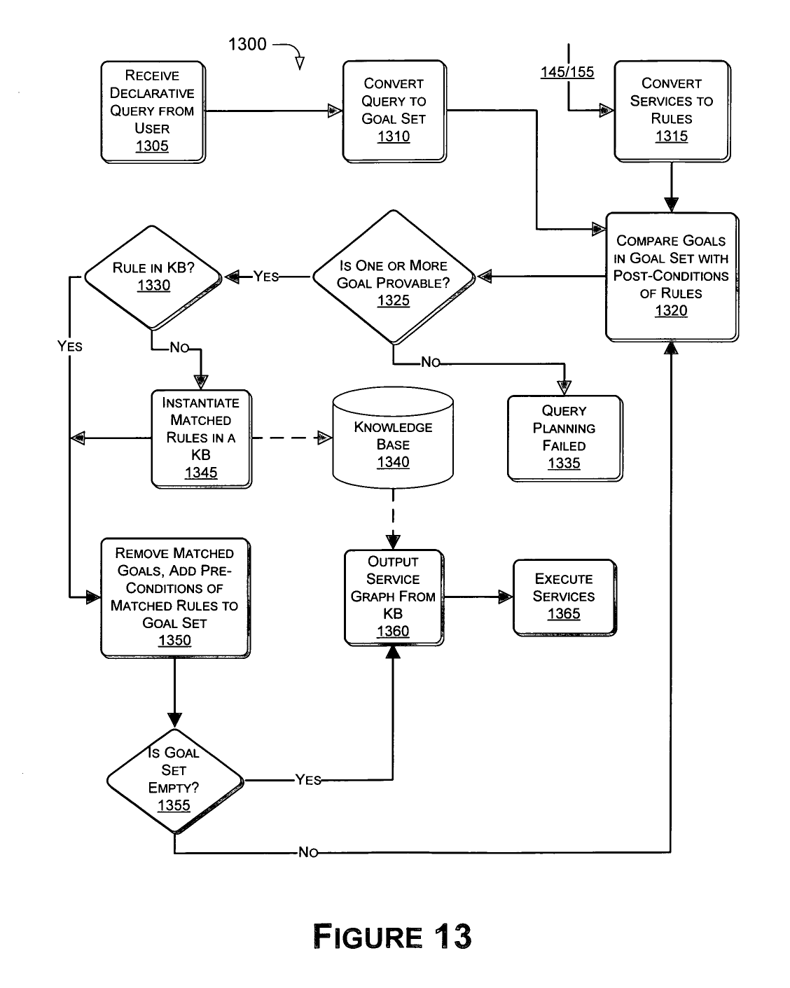

FIG. 13 illustrates a flowchart of a process 1300 performed to process queries 115 according to the teachings herein. In block 1305, a query 115 in declarative form is received from the users 105. In block 1310, the input query 115 is converted into a goal set of post-conditions. In subsequent stages, the process 1300 tries to prove these post-conditions using sensors 155 and/or services 205 that are in the service library 140. Thus, the set of post-conditions output from block 1310 may be viewed as a set of goals to be met by the composition of services 205 and/or sensors 155. In block 1315, a set of pre-existing services 145 and/or sensors 155 are converted into rules that have pre-conditions and post-conditions. Similarly, a set of sensors 155 are converted into rules with no pre-conditions but only post-conditions. As discussed elsewhere herein, the pre-existing services 145 and sensors 155 may be stored in a library 140, and/or could be extracted from a set of pre-existing applications stored in the library 140. As suggested by the layout shown in FIG. 13, the processing represented by block 1315 may proceed previously to, or in parallel with, the processing represented by block 1310. However, in other implementations, blocks 1310 and 1315 may be processed sequentially.

In block 1320, the post-conditions into which the elements of the input query 115 were converted (in block 1310) are compared with the post-conditions of the rules into which the pre-existing services 145 and sensors 155 were converted (in block 1315). In other words, viewing the post-conditions of the input query 115 as a goal set, block 1320 compares the goal set to the post-conditions of the rules that are output from block 1315.

Block 1325 checks the comparison results from block 1320. If there is any rule matching a post-condition (i.e., goal) of the input query 115, then this part of the input query is provable. Thus, block 1325 picks a matching rule and sends it to block 1330, taking the “Yes” branch from block 1325. On the other hand, if there is no rule that can match any of the post conditions of the input query 115, then the planner 1300 declares that the query is unachievable in block 1335, taking the “No” branch from block 1325.

In block 1330, the rule picked in block 1325 is checked to see whether it is instantiated in a knowledge base (KB) 1340. Note that the KB 1340 is typically empty initially. If the given rule does not exist in the KB 1340, (“No” branch from block 1330), then it is instantiated by block 1345 and inserted in the KB 1340. Otherwise (“Yes” branch from block 1330), in block 1350, the pre-conditions of the matching rule are added to the query 115, and the post-conditions of the matching rule are removed from the query 115.

In block 1355, the process 1300 evaluates whether the set of pre- and post-conditions in query 115 (i.e., the goal set) is empty. If goal set is not empty, the process 1300 takes the “No” branch from block 1355, and the process 1300 returns to block 1320 to repeat.

Referring back to block 1355, if the set is empty, the process 1300 takes the “Yes” branch to block 1360, which outputs a service graph from the KB 1340. Recall that this service graph corresponds to the services that were instantiated by block 1345 in the process of recursively proving the query 115. In block 1365, the output service graph is executed.

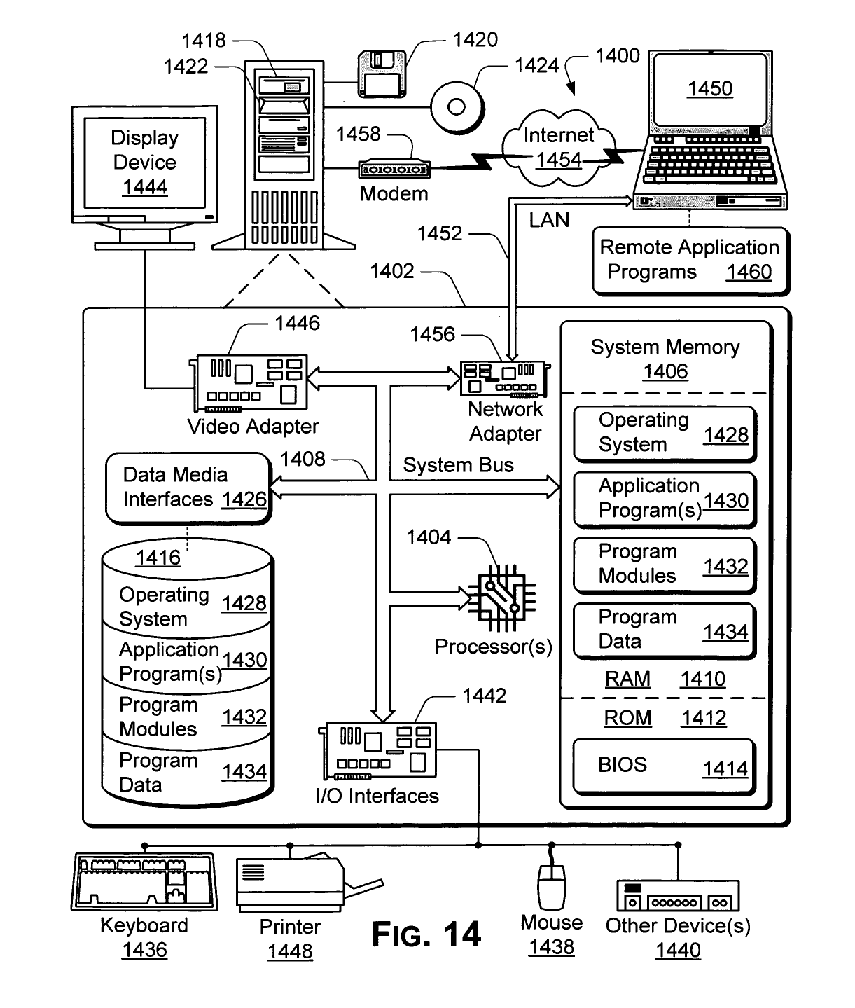

FIG. 14 illustrates an exemplary computing environment 1400 within which declarative queries for sensor networks, as well as the computing, network, and system architectures described herein, can be either fully or partially implemented. Exemplary computing environment 1400 is only one example of a computing system and is not intended to suggest any limitation as to the scope of use or functionality of the architectures. Neither should the computing environment 1400 be interpreted as having any dependency or requirement relating to any one or combination of components illustrated in the exemplary computing environment 1400.

The computer and network architectures in computing environment 1400 can be implemented with numerous other general purpose or special purpose computing system environments or configurations. Examples of well known computing systems, environments, and/or configurations that may be suitable for use include, but are not limited to, personal computers, server computers, client devices, hand-held or laptop devices, microprocessor-based systems, multiprocessor systems, set top boxes, programmable consumer electronics, network PCs, minicomputers, mainframe computers, gaming consoles, distributed computing environments that include any of the above systems or devices, and the like.

The computing environment 1400 includes a general-purpose computing system in the form of a computing device 1402. The computing device 1402 can implement all or part of the query processor 120, the inference engine 170, and/or the application processor or microserver 175, as shown in FIG. 1, or the query planning engine 305, the service embedding engine 315, the runtime service 325, and/or the execution engine 335, as shown in FIG. 3. The components of computing device 1402 can include, but are not limited to, one or more processors 1404 (e.g., any of microprocessors, controllers, and the like), a system memory 1406, and a system bus 1408 that couples the various system components. The one or more processors 1404 process various computer executable instructions to control the operation of computing device 1402 and to communicate with other electronic and computing devices. The system bus 1408 represents any number of several types of bus structures, including a memory bus or memory controller, a peripheral bus, an accelerated graphics port, and a processor or local bus using any of a variety of bus architectures. Taken in whole or in part, the computing device 1402 may be suitable for hosting the query processor 120, the interference engine 170, and/or the sensor nodes 155.

Computing environment 1400 includes a variety of computer readable media which can be any media that is accessible by computing device 1402 and includes both volatile and non-volatile media, removable and non-removable media. The system memory 1406 includes computer readable media in the form of volatile memory, such as random access memory (RAM) 1410, and/or non-volatile memory, such as read only memory (ROM) 1412. A basic input/output system (BIOS) 1414 maintains the basic routines that facilitate information transfer between components within computing device 1402, such as during start-up, and is stored in ROM 1412. RAM 1410 typically contains data and/or program modules that are immediately accessible to and/or presently operated on by one or more of the processors 1404.

Computing device 1402 may include other removable/non-removable, volatile/non-volatile computer storage media. By way of example, a hard disk drive 1416 reads from and writes to a non-removable, non-volatile magnetic media (not shown), a magnetic disk drive 1418 reads from and writes to a removable, non-volatile magnetic disk 1420 (e.g., a “floppy disk”), and an optical disk drive 1422 reads from and/or writes to a removable, non-volatile optical disk 1424 such as a CD-ROM, digital versatile disk (DVD), or any other type of optical media. In this example, the hard disk drive 1416, magnetic disk drive 1418, and optical disk drive 1422 are each connected to the system bus 1408 by one or more data media interfaces 1426. The disk drives and associated computer readable media provide non-volatile storage of computer readable instructions, data structures, program modules, and other data for computing device 1402.

Any number of program modules can be stored on RAM 1410, ROM 1412, hard disk 1416, magnetic disk 1420, and/or optical disk 1424, including by way of example, an operating system 1428, one or more application programs 1430, other program modules 1432, and program data 1434. Each of such operating system 1428, application program(s) 1430, other program modules 1432, program data 1434, or any combination thereof, may include one or more embodiments of the systems and methods described herein.

Computing device 1402 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example and not limitation, communication media includes wired media such as a wired network or direct-wired connection, and wireless media such as acoustic, RF, infrared, other wireless media, and/or any combination thereof.

A user can interface with computing device 1402 via any number of different input devices such as a keyboard 1436 and pointing device 1438 (e.g., a “mouse”). Other input devices 1440 (not shown specifically) may include a microphone, joystick, game pad, controller, satellite dish, serial port, scanner, and/or the like. These and other input devices are connected to the processors 1404 via input/output interfaces 1442 that are coupled to the system bus 1408, but may be connected by other interface and bus structures, such as a parallel port, game port, and/or a universal serial bus (USB).

A display device 1444 (or other type of monitor) can be connected to the system bus 1408 via an interface, such as a video adapter 1446. In addition to the display device 1444, other output peripheral devices can include components such as speakers (not shown) and a printer 1448, as well as any of the sensors 155 described herein, which can be connected to computing device 1402 via the input/output interfaces 1442.

Computing device 1402 can operate in a networked environment using logical connections to one or more remote computers, such as remote computing device 1450. By way of example, remote computing device 1450 can be a personal computer, portable computer, a server, a router, a network computer, a peer device or other common network node, and the like. The remote computing device 1450 is illustrated as a portable computer that can include any number and combination of the different components, elements, and features described herein relative to computing device 1402.

Logical connections between computing device 1402 and the remote computing device 1450 are depicted as a local area network (LAN) 1452 and a general wide area network (WAN) 1454. Such networking environments are commonplace in offices, enterprise-wide computer networks, intranets, and the Internet. When implemented in a LAN networking environment, the computing device 1402 is connected to a local network 1452 via a network interface or adapter 1456. When implemented in a WAN networking environment, the computing device 1402 typically includes a modem 1458 or other means for establishing communications over the wide area network 1454. The modem 1458 can be internal or external to computing device 1402, and can be connected to the system bus 1408 via the input/output interfaces 1442 or other appropriate mechanisms. The illustrated network connections are merely exemplary and other means of establishing communication link(s) between the computing devices 1402 and 1450 can be utilized.

In a networked environment, such as that illustrated with computing environment 1400, program modules depicted relative to the computing device 1402, or portions thereof, may be stored in a remote memory storage device. By way of example, remote application programs 1460 are maintained with a memory device of remote computing device 1450. For purposes of illustration, application programs and other executable program components, such as operating system 1428, are illustrated herein as discrete blocks, although it is recognized that such programs and components reside at various times in different storage components of the computing device 1402, and are executed by the one or more processors 1404 of the computing device 1402.

Although embodiments of declarative queries of sensor networks have been described in language specific to structural features and/or methods, it is to be understood that the subject of the appended claims is not necessarily limited to the specific features or methods described. Rather, the specific features and methods are disclosed as exemplary implementations of declarative queries of sensor networks.

1. A method comprising:
receiving at least one query from at least one user in a declarative programming language; and
automatically specifying at least one service executable on a network of sensors to obtain a response to the query.

2. The method of claim 1, further comprising receiving at least one specification of at least one constraint applicable to the service, wherein the constraint enables selection among alternative services to respond to the query.

3. The method of claim 1, further comprising receiving at least one specification of a range of constraints applicable to the service, wherein the range of constraints enable selection among alternative services to respond to the query.

4. The method of claim 1, further comprising converting the service to at least one rule having at least one post-condition.

5. The method of claim 4, further comprising matching at least one element of the query to at least one post-condition of the rule.

6. The method of claim 5, further comprising adding the pre-condition of the rule to the query.

7. The method of claim 1, further comprising instantiating the service.

8. The method of claim 1, further comprising analyzing at least one pre-existing service to determine whether to instantiate the service.

9. The method of claim 8, wherein analyzing at least one pre-existing service includes analyzing an event stream output from the pre-existing service to an event stream defined as input to the service.

10. The method of claim 1, further comprising sharing an output event stream of at least one given pre-existing service with the service.

11. The method of claim 1, further comprising validating at least one event stream used to prove the service.

12. A user interface comprising:
a first area adapted to display a graphical representation of at least one service; and
at least a second area adapted to display a list of post-conditions of rules corresponding to the service.

13. The user interface of claim 12, further comprising at least a third area adapted to enable a user to select the post-condition for inclusion in a query.

14. The user interface of claim 13, wherein at least one of the first area and the second area is updated in response to a query specified by the user.

15. One or more computer readable media comprising computer executable instructions that, when executed, direct a computing device to:
present a user interface to at least one user that illustrates a current state of a sensor network;
enable the user to formulate at least one query using the user interface;
automatically specify at least one service using a declarative programming language to obtain a response to the query; and
present the response to the user.

16. One or more computer readable media as recited in claim 15, further comprising computer executable instructions that, when executed, direct the computing device to analyze at least one pre-existing service to determine whether to instantiate the service.

17. One or more computer readable media as recited in claim 15, further comprising computer executable instructions that, when executed, direct the computing device to analyze an event stream output from the pre-existing service to an event stream defined as input to the service.

18. One or more computer readable media as recited in claim 15, further comprising computer executable instructions that, when executed, direct the computing device to convert the service to at least one rule having at least one pre-condition and at least one post-condition.

19. One or more computer readable media as recited in claim 15, further comprising computer executable instructions that, when executed, direct the computing device to match at least one element of the query to at post-condition of the rule.

20. One or more computer readable media as recited in claim 15, wherein the computer executable instructions direct the computing device to enable the user to formulate a query for at least one of a speed and a position of a moving object within a region of interest.
